(19) United States
(12) Patent Application Publication
(10) Pub. No.: US 2008/0239710 A1
(43) Pub. Date: Oct. 2, 2008

(54) Twist-Type Stick Container

(76) Inventors: Yukitomo Yuhara, Chiba (JP); Takayuki Tokushita, Tokyo (JP)

Correspondence Address: MORRISON & FOERSTER LLP, 1650 TYSONS BOULEVARD, SUITE 400, MCLEAN, VA, 22102, US

(21) Appl. No.: 10/587,077

(22) PCT Filed: Jan. 19, 2005
(86) PCT No.: PCT/JP2005/000579

§ 371 Date: May 22, 2008

(30) Foreign Application Priority Data
Jan. 22, 2004 (JP) 2004-014049

(51) Int. Cl. F21V 33/00

(52) U.S. Cl. 362/154

(57) ABSTRACT

[Problem] To provide a twist-type stick container that can be decorated in various ways using light, so as to produce an aesthetically pleasing or new and original decorative effect that creates a characteristic and unique atmosphere.

[Solving Means] A twist-type stick container includes a hollow cylindrical container body 2 formed with a spiral groove 7 in its inner circumferential face; a light source device 11 provided in the container body; a hollow cylindrical cover 3 provided in the container body to be rotatable relative thereto and that is formed with a longitudinal slit 9 in a portion formed with the spiral groove; a holder 4 formed with a protrusion 10 that extends through the longitudinal slit and engages with the spiral groove, the holder being formed with therein an aperture 16 that allows light from the light source device to pass through toward a stick formed of a translucent material 5, the holder being provided in the cover so as to be relatively movable in a vertical direction while holding the stick; and a cap 6 that is attachably and detachably attached to the container body while covering the cover.

### TECHNICAL FIELD

The present invention relates to a twist-type stick container that can be decorated in various ways using light so as to produce an aesthetically pleasing effect or a novel and original decorative effect which creates a characteristic and unique atmosphere.

### BACKGROUND ART

To date, among containers that contain a stick material, there is known an twist-type stick container that lets a lipstick as a stick material out from the container when it is used and lowers it into the container when it is to be contained as disclosed in Japanese Patent Application Laid-Open Publication No. 9-182621. Such stick container has been usually decorated in various methods so as to have a higher design value. For example, the container has been decorated on the surface such as by coloring with paint, surface treating by sputtering or the like, forming a planar or three-dimensional character or pattern using a plate member or a transfer sheet, or attaching a pattern or the like and laying a transparent or half-transparent layer thereon.

The Applicant of this application has filed Japanese Patent Application No. 2002-221189 and No. 2003-116289 as related prior applications.

### DISCLOSURE OF INVENTION

### Problems to be Solved by the Invention

All of the decorations achieved by the above conventional techniques are already common, however, and have limitations in terms of techniques of decorating.

Accordingly, the inventors focused on the use of light from a light source that has not been considered in relationship to the above conventional decorating techniques, and found that the stick container could be given an effect of an aesthetically pleasing decoration which has never been seen before by decorating with light, thus completing the present invention.

The present invention was made in view of the above problem, and an object of the invention is to provide a twist-type stick container that can be decorated in various ways using light, so as to produce an aesthetically pleasing or new and original decorative effect which creates a characteristic and unique atmosphere.

### Means for Solving the Problems

An twist-type stick container according to the present invention comprises a hollow cylindrical container body formed with a spiral groove in its inner circumferential face; a light source device provided in the container body; a hollow cylindrical cover provided in the container body to be rotatable relative thereto and that is formed with a longitudinal slit associated with a portion formed with the spiral groove; a holder formed with a protrusion that extends through the longitudinal slit and engages with the spiral groove and formed with a light transmitting portion that allows light from the light source device to pass through toward a stick formed of a translucent material, the holder being provided in the cover so as to be relatively movable in a vertical direction while holding the stick; and a cap that is attachably and detachably attached to the container body while covering the cover.

The container body and the cover may be formed of opaque material preventing the transmission of light.

Further, the light source device may comprise a light source, a controller that controls light emission of the light source, and a battery that supplies electric power to the controller and the light source.

### INDUSTRIAL APPLICABILITY

The twist-type stick container according to the present invention can be decorated in various ways using light so as to produce an aesthetically pleasing or a new and original decorative effect which creates a characteristic and unique atmosphere.

### BRIEF DESCRIPTION OF DRAWINGS

FIG. 1 is a perspective view illustrating a preferred embodiment of a twist-type stick container according to the present invention.

FIG. 2 is a side sectional view of the twist-type stick container of FIG. 1.

FIG. 3 is a side partially cut-away view of the twist-type stick container of FIG. 1 showing a state where the stick has come out.

### EXPLANATION OF REFERENCE NUMERALS

1 Twist-type stick container, 2 Container body, 3 Cover, 4 Holder, 5 Stick, 6 Cap, 7 Spiral groove, 9 Longitudinal slit, 10 Protrusion, 11 Light source device, 12 RGB light source, 13 Electronic board, 14 Battery, 16 Through hole

### BEST MODE FOR CARRYING OUT THE INVENTION

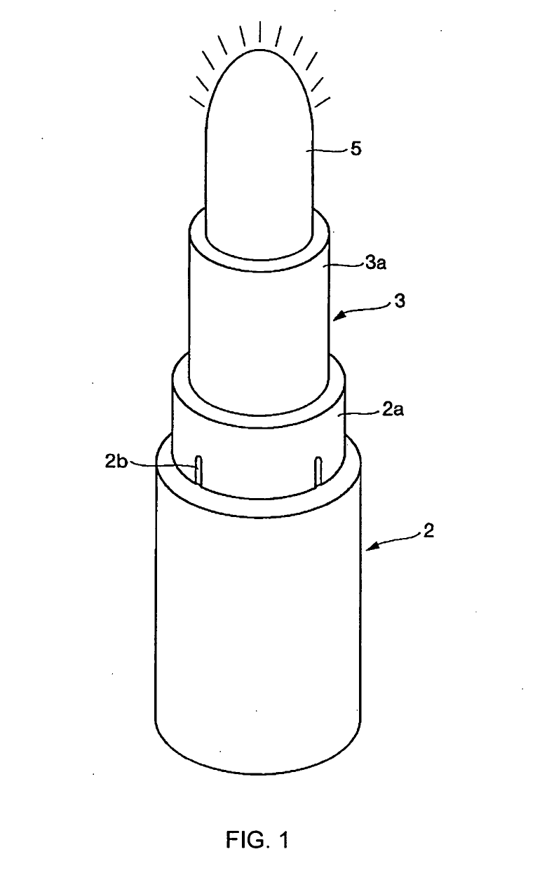

A preferred embodiment of a twist-type stick container according to the present invention will be described below in detail with reference to the accompanying drawings. A twist-type stick container 1 of this embodiment, as shown in FIGS. 1 to 3, is configured generally by being provided with a hollow cylindrical cover 3 provided inside a hollow cylindrical container body 2, and also with a hollow cylindrical holder 4 provided inside the cover 3, and a stick 5 such as a lipstick being held in the holder 4. A cap 6 is adapted to be attachably and detachably attached to a top end section 2a having a reduced diameter of the container body 2 so as to cover the upper portion of the cover 3.

The illustrative example illustrates a lipstick container that holds a lipstick as the stick 5 by the holder 4, as the twist-type stick container 1. Needless to say, however, the twist-type stick container 1 may be a container that contains any kind of stick 5, and is not limited to such lipstick container.

The container body 2 is formed with open upper and lower ends, and in the inner circumferential face thereof a spiral groove 7 is formed in a vertical direction that is its axial direction over a length corresponding to the amount the stick 5 is let out. A ring-shaped bottom plate 8 is attachably and detachably screwed into the open lower end of the container body 2. Also, the cover 3 is formed to have open upper and lower ends and is formed to be longer than the container body 2, and is provided inside the container body 2 so as to be relatively rotatable thereto. In a state where the cover 3 is attached to the container body 2, an upper end section 3a of the cover 3 protrudes outwardly from the upper end section 2a of the container body 2. Longitudinal slits 9 are formed in the part of the cover 3 that is surrounded by the container body 2 so as to be associated with the portion in which the spiral groove 7 is formed.

The holder 4 has a partition 4a in its center portion in the vertical direction, is formed to have open upper and lower ends, and is provided inside the cover 3 so as to be relatively movable thereto in the vertical direction. Protrusions 10 that extend through the longitudinal slits 9 to engage with the spiral groove 7 protrude integrally from the outside of the lower end section of the holder 4. The stick 5 is held on the partition 4a of the holder 4. The cap 6 is shaped like a hollow cylinder with its upper end closed, and is fitted at ribs 2b formed in the upper end section 2a of the container body 2 to be attachably and detachably attached to the container body 2.

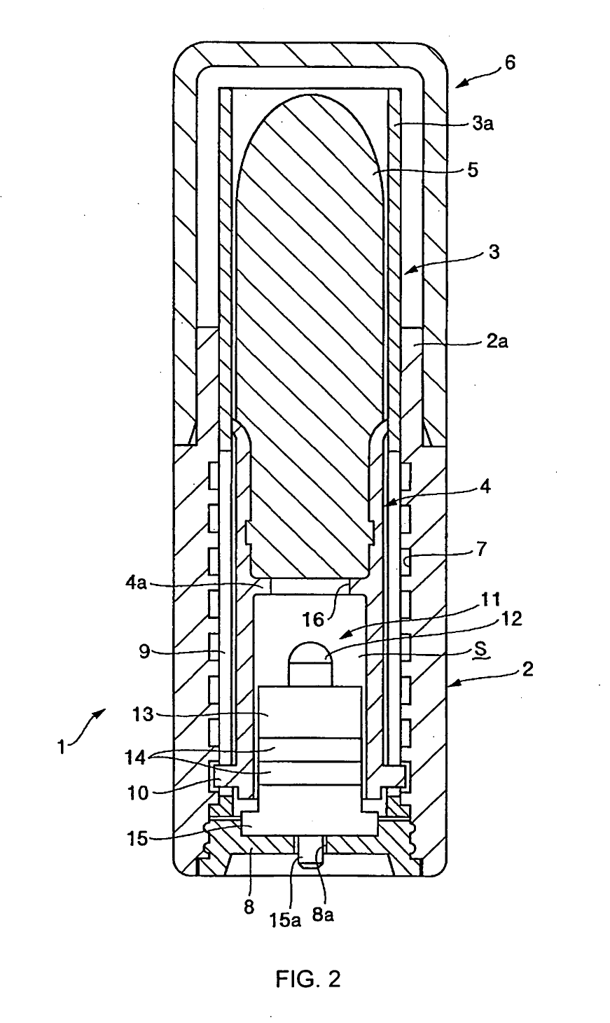

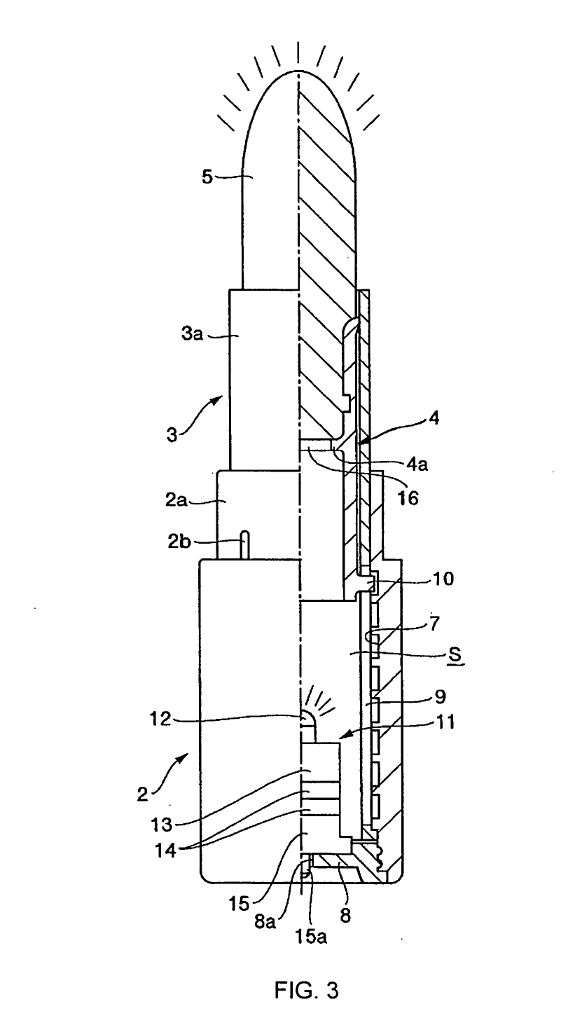

With the twist-type stick container 1 having the above configuration of this embodiment, in a state where the stick 5 is contained and the cap 6 is fitted thereon as shown in FIG. 2, the container body 2 and the cap 6 form the outside appearance of the stick container 1 with the cover 3 and the holder 4 concealed inside. On the other hand, when the stick 5 is to be taken out, the cap 6 is removed and by twisting relatively the container body 2 and the cover 3, for example, twisting the container body 2 clockwise, the protrusions 10 of the holder 4 that extend through the longitudinal slits 9 move along the spiral groove 7. Then, as shown in FIGS. 1 and 3, the holder 4 is moved upwards, and the stick 5 projects out from the upper end section 3a of the cover 3. Further, when the stick 5 is to be contained, by twisting relatively the container body 2 and the cover 3 in the opposite direction, for example, twisting the container body 2 counterclockwise, the protrusions 10 are moved along the spiral groove 7 in the opposite direction, the holder 4 is lowered, and the stick 5 is contained inside the cover 3.

In particular, in the twist-type stick container 1 of this embodiment, a light source device 11 is provided in the container body 2, and the container body 2 and the cover 3 are formed of material preventing the transmission of light such as metal or colored, opaque synthetic resin. On the other hand, in the holder 4, a light transmitting portion that can transmit light from the light source device 11 is formed. Particularly, the stick 5 to be held in the holder 4 is formed of a translucent material. The light source device 11 is attached fixed on the ring-shaped plate 8 and provided in a space S partitioned under the partition 4a of the holder 4, that moves vertically inside the container body 2.

The light source device 11 is configured by an RGB light source 12 that is arranged to be surrounded by the holder 4 and the cover 3, and thus the container body 2; an electronic board 13 having electronic components mounted that form a controller to control the light emission amount of each color of the RGB light source 12; a battery 14 such as a button-type battery for supplying electric power to the electronic board 13 and via the electronic board to the RGB light source 12; and a switch 15 that switches on and off the power supply from the battery 14 to the electronic board 13, or the like, with the above components arranged stacked vertically. By attaching and detaching the ring-shaped body 8, components can be replaced. The RGB light source 12 is mounted directly on the electronic board 13, and an operation push button 15a of the switch 15 is exposed at the bottom through an opening 8a of the ring-shaped plate 8.

As the RGB light source 12, various already-known devices can be used such as an LED or an organic electro-luminescence (EL) device. The electronic components forming the controller includes a control element such as an IC chip having written therein a program to control the emission of the RGB light source 12, and when the switch 15 is switched on to supply electric power from the battery 14, the RGB light source 12 is made to emit light according to the programming.

As the way to make the RGB light source 12 emit light may be, for example, making the total emission amount increase or decrease for gradual blinking, and during the blinking, changing sequentially the emission proportion of red, green, and blue to emit lights of various colors, or to make the light source 12 blink at short time-intervals while each time making the light source 12 emit the light in various colors. Including the above, any program can be stored in the control element. Needless to say, the light source may be a monochromatic light source, and is not limited to the RGB light source 12.

On the other hand, in this embodiment, the light transmitting portion formed in the holder 4 is constituted by an aperture 16 formed in the partition 4a located directly above the RGB light source. In the case where the aperture 16 is formed in this way, the holder 4 may be made of material that prevents the transmission of light as similar to the container body 2 or the like. However, together with the formation of the aperture 16, the entire holder 4 may of course be formed of colorless or colored, transparent or half-transparent synthetic resin that transmits light. Alternatively, without forming the aperture 16, the holder 4 itself may be formed of colorless or colored, transparent or half-transparent synthetic resin so that the entire holder functions as the light transmitting portion. Furthermore, a part of the holder 4 facing the RGB light source 12 may be formed of a transparent material such as a synthetic resin having light transparency, a glass material, or a crystal material, with the remaining part being formed of a light-tight material. In this case, the holder 4 can be produced by a method such as, e.g., insert molding, that is in injection molding of the holder 4 or the like from synthetic resin, a transparent material is placed beforehand inside a mold and is integrated with injected opaque synthetic resin.

Next, the action of the twist-type stick container 1 having the above configuration of this embodiment is described. When the switch 15 is switched on with the cap 6 removed from the container body 2, the battery 14 supplies electric power to the RGB light source 12 and the electronic board 13, and the RGB light source 12 blinks or the like and emits light with various colors and degrees of brightness according to the program written in the control element. As shown in FIG. 2, if the holder 4 is formed of an opaque material, the light from the RGB light source 12 is irradiated through the aperture 16 and through the stick 5 to the outside, and if the holder 4 is formed of a transparent material, the light is irradiated also through the holder 4 to the outside to illuminate the holder 4 and the stick 5 in various ways. On the other hand, when the switch 15 is switched off, the RGB light source 12 is put out.

As such, in the twist-type stick container 1 of this embodiment that has been described as above, the light source device 11 is provided in the container body 2, and the stick 5 and the holder 4 are formed to be translucent, the light emitted from the RGB light source 12 in the container body 2 passes through the holder 4 set in the container body 2 and the stick 5 held in the holder 4, and illuminates them. Thus, the holder 4 and the stick 5 can be decorated in various ways with use of the light, and thereby the twist-type stick container 1 produces an aesthetically pleasing or a new and original decorative effect which creates a characteristic and unique atmosphere.

Moreover, by forming the container body 2 and the cover 3 from a light-tight material preventing the transmission of light, the outside of the stick container 1 can take on clear contrast of light. Further, since the controller is made to control the light emission of the RGB light source 12, various choreographing effects with use of light that are visually appealing are produced, and thus an aesthetically pleasing or a new and original decoration which creates a characteristic and unique atmosphere can be given to the twist-type stick container 1.

1. A twist-type stick container comprising:
a hollow cylindrical container body formed with a spiral groove in its inner circumferential face;
a light source device provided in the container body;
a hollow cylindrical cover provided in the container body to be rotatable relative thereto and that is formed with a longitudinal slit formed in a portion formed with the spiral groove;
a holder formed with a protrusion that extends through the longitudinal slit and engages with the spiral groove, the holder being formed with a light transmitting portion that allows light from the light source device to pass through toward a stick formed of a translucent material, the holder being provided in the cover so as to be relatively movable in a vertical direction while holding the stick; and
a cap that is attachably and detachably attached to the container body while covering the cover.

2. A twist-type stick container according to claim 1, wherein the container body and the cover are formed of opaque material preventing the transmission of light.

3. A twist-type stick container according to claim 1 or 2, wherein the light source device comprises a light source, a controller that controls light emission of the light source, and a battery that supplies electric power to the controller and the light source.
